(19) United States
(12) Patent Application Publication
(10) Pub. No.: US 2009/0004004 A1
(43) Pub. Date: Jan. 1, 2009

(54) Rotorcraft

(76) Inventor: Paul Vincenzi, London (GB)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/575,944

(22) PCT Filed: Sep. 22, 2005
(86) PCT No.: PCT/GB2005/003662

§ 371 Date: Sep. 3, 2008

(30) Foreign Application Priority Data
Sep. 23, 2004 (GB) 0421248.6

(51) Int. Cl. B64C 27/82; B64C 13/00

(52) U.S. Cl. 416/1; 244/17.25; 244/75.1

(57) ABSTRACT

There is described a rotary wing aircraft comprising a fuselage (5), a main rotor (3) rotatable e in a main rotor plane relative to the fuselage for supporting the aircraft in flight, and a plurality of control thrusters (7) each operable to provide a thrust force acting in a tangential direction relative to the main rotor and in a plane parallel to and spaced from the main rotor plane. The plurality of control thrusters may comprise a pair of oppositely directed thrusters, the pair being mounted for selective rotation relative to the fuselage about the main rotor axis. Alternatively and preferably, the plurality of thrusters may comprise three or more thrusters spaced in the circumferential direction of the main rotor. There is also described a tilt-rotor aircraft in which such an array of thrusters is provided for lateral control in hovering flight, and directional control in forward flight.

### BACKGROUND OF THE INVENTION

The present invention relates to rotary wing aircraft, and is particularly concerned with a control system for balancing the rotor torque and controlling the direction of the rotor lift in a rotary wing aircraft. A further concern of the invention is to provide a control arrangement for use with a tilt-rotor type aircraft, or for directional control in a conventional aircraft.

In a conventional helicopter, a main rotor rotates in a horizontal plane to provide vertical lift, the amount of lift being controlled by a collective pitch control which varies the incidence angle of the rotor blades in unison. Angling of the thrust vector to produce forward, sideways or rearwards flight is achieved by a cyclic pitch control acting on the rotor blades to produce a tilting of the rotor disk out of the horizontal plane to generate a horizontal (longitudinal or lateral) thrust. The torque applied from the helicopter fuselage to the rotor is balanced by a thruster, conventionally mounted in the tail of the helicopter to control yawing of the helicopter fuselage.

The provision of collective and cyclic pitch control to the main rotor blades results in a complicated and expensive structure at the rotor hub, increasing both construction and maintenance costs. Furthermore, conventional helicopter rotor blades are hinged at the root and thus produces appreciable “flapping” movement of the blade as cyclic pitch control is applied to tilt the rotor disk relative to the aircraft fuselage.

Helicopters are seldom operated in confined environments, such as for rescuing occupants from windows of buildings, due to the catastrophic consequences of contact of the rotor tips with fixed structures. A feature of the present proposal is to provide a duct or shield surrounding the main rotor which can survive a low-speed impact without damage to the rotor blades. Such a shield is difficult to arrange in an aircraft with cyclic pitch control due to the large clearances required to accommodate blade flapping movement within the shield making the shield unacceptably cumbersome.

In a tilt-rotor aircraft, a rotor is mounted to the aircraft fuselage for tilting between a take-off position in which one or more rotors provide vertical lift to raise the aircraft off the ground, and a flight position wherein the rotor or rotors provide forward thrust and the aircraft is supported by conventional aerodynamic forces acting on wings. The wings and rotors may rotate as a unit relative to the fuselage, or the wings may be fixed to the fuselage and only the rotor or rotors be pivotally mounted.

To provide for control of tilt-rotor aircraft during take off and landing, when aerodynamic forces on the wings and tailplanes are small due to low airspeed, the rotor or rotors are provided with collective and cyclic pitch control as helicopter-type craft, and single rotor craft also need yaw control arrangements usually a tail rotor operating during hover and low-speed flight. The complexity of the rotor assemblies is thus increased and cost of the aircraft both in production and maintenance rises.

The present invention seeks to provide a control arrangement for rotorcraft or for tilt-rotor aircraft which utilises a main rotor without cyclic pitch control. Optionally the main rotor may be a fixed-pitch rotor, further simplifying the rotor head structure by avoiding both collective and cyclic pitch control structures. The control system seeks also to balance the main rotor torque and thus provide yaw control in helicopters, and in tilt-wing aircraft during hovering, landing and takeoff, without the need for conventional tail rotors or tail thrusters.

### SUMMARY OF THE INVENTION

One aspect of the present invention provides a control arrangement for a rotary-wing aircraft which can simultaneously balance the torque of a lifting rotor and provide for lateral control, without the need for cyclic pitch control of the rotor blades.

A further aspect of the invention concerns a rotary-wing aircraft with one or more fixed-pitch lifting rotors, which can provide both a counter-balancing torque and lateral thrust control.

In a yet further aspect of the invention, a control arrangement for a tilt-rotor aircraft is provided. In such aircraft, one or more rotors are mounted to the aircraft for rotation in a horizontal plane to generate lift to support the aircraft in hover, take-off and landing modes, the rotor or rotors being tiltable to rotate in a generally vertical plane to provide forward thrust for conventional wing-borne flight.

In one embodiment of the invention, the control arrangement for a rotary-wing aircraft comprises a number of thrusters mounted to the fuselage of the aircraft and arranged in relation to the main lifting rotor of the aircraft so that the lines of action of the thrusters are in a plane spaced from the plane of the main rotor disk and are directed circumferentially relative to the rotor disk. An array of thrusters may be positioned above and/or below the main rotor, and the arrays may be mounted either to the fuselage or to a boom extending axially of the rotor.

The array of thrusters is able to simultaneously provide a moment or torque to counteract the torque of the main rotor and a force directed radially in relation to the main rotor axis and spaced from the plane of the rotor.

When a radial force is applied at a location spaced from the plane of the rotor, or more specifically spaced vertically from the centre of mass of the aircraft, the aircraft is urged to tilt. This tilting movement produces a lateral component in the lift force from the main rotor, and the aircraft moves sideways in the direction of the lateral force. To maintain height, lifting power is increased.

In embodiments of the invention which have arrays of thrusters above and below the plane of the rotor, the resultant radial force may be above, below or in the plane of the rotor. This latter case can provide fine control of lateral movement, since application of the lateral force will not tilt the rotor disk if the lateral force acts through the centre of mass of the aircraft. Using two thruster arrays, the aircraft may be moved laterally in any direction while maintaining the rotor disk horizontal, the sideways movement being produced by the thruster force only.

Preferably three thrusters are provided in each array, the circumferential angular spacing between the thrusters being most preferably substantially equal. The thrusters are most preferably symmetrically positioned with respect to the longitudinal axis of the aircraft's fuselage. A pure couple to counteract the rotor torque is produced by making the thrust forces from the thrusters equal. A combination of a couple to counteract the rotor torque and a directable lateral force to provide directional control can be produced by varying the amount of thrust from each thruster and optionally its circumferential direction. While three thrusters is the preferred number, arrays of four or more thrusters may be used, preferably mounted at symmetrical positions relative to the longitudinal axis of the aircraft.

In an alternative arrangement, however, two oppositely-directed thrusters may be provided. The thrusters may be operated to produce a couple to counteract the rotor torque, and a lateral thrust may be generated by making the thrusts from the thrusters unequal. The pair of thrusters are mounted as a unit for rotation about the main rotor axis so that the direction of a lateral thrust generated by the thrusters may be controlled by selectively rotating the thruster assembly to a desired orientation relative to the aircraft's fuselage.

The use of thrusters to generate a torque-resisting couple and lateral force to control direction of flight removes the need for a cyclic pitch control on the main lifting rotor, simplifying the rotor head structure.

Since no cyclic pitch control is used on the main rotor, the plane of the rotor disc is substantially fixed relative to the aircraft's fuselage, and a surrounding duct may be mounted to the fuselage to enclose the rotor with minimal clearance at the rotor tips to improve rotor performance. The duct may also serve as a shield to provide protection against blade tip contact with fixed structures and thus permit the craft to be operated in an enclosed environment or close to buildings or cliffs, which is extremely hazardous for conventional aircraft. The thrusters in such craft may be positioned inboard of the shield to protect against impact with vertical faces, or may have their own protective shrouds. The shield may alternatively be a structure surrounding the rotor disc but out of its plane, either above or below, with the same function of mitigating the effect of contact with a fixed structure by protecting the rotor and/or thrusters.

The thrusters may be reaction jets fed from inlets in the duct surface, using air pressurised by the main rotor.

The absence of a cyclic pitch control also enables the design of the rotor blades to be optimised as regards their pitch, chord and camber at different radii, to distribute lift evenly over the rotor disk radius, increasing the efficiency of the rotor.

In an alternative embodiment of the invention, a control arrangement for a tilt-rotor aircraft is provided. In such aircraft, one or more rotors are mounted to the aircraft for rotation in a horizontal plane to generate lift to support the aircraft in hover, take-off and landing modes. The rotor or rotors are pivotable into a vertical plane to provide forward thrust for conventional wing-borne flight of the aircraft. The rotors may be pivotally mounted to the aircraft fuselage, with the aircraft's wing being fixed relative to the fuselage. Alternatively the wing and rotor or rotors may both be pivotally attached to the fuselage so that when in rotor-borne flight the wing area exposed to rotor downwash is minimised. The flight control arrangement comprises as before a number of thrusters fixed in relation to the rotor or rotors of the aircraft, and pivotable therewith relative to the fuselage, so that the lines of action of the thrusters are spaced from the plane of the rotor disk and are directed circumferentially relative to the rotor disk. The thrusters are arranged so that they can provide a moment to counteract the torque of the rotor and/or a radially-directed force directed radially in relation to the rotor axis.

As in the first arrangement described above, the thrusters of the tilt-rotor craft may be three in number, fixed in position relative to the main rotor, and operable to deliver thrust forces in a plane parallel to and spaced from the main rotor plane, in circumferential directions relative to the main rotor. By individually controlling the magnitude and circumferential direction of the thrust of each thruster, a moment to counteract the rotor torque and optionally a radial force to move the aircraft in the horizontal plane may be produced, to control the aircraft in hovering and low-speed flight regimes. The tilt-rotor craft may have two or more main rotors, each with a set of thrusters.

In an alternative tilt-rotor aircraft arrangement, not illustrated, the thrusters may be mounted to the aircraft fuselage to provide lateral and longitudinal control forces and/or moments, while one or more tilting rotors are mounted to the fuselage provide lift and forward thrust for flight. The tilting rotors may be mounted to a tilting wing, or a fixed wing may be mounted to the fuselage to support tilting rotors.

When the tilt-rotor aircraft is operating with its rotor or rotors tilted to a vertical plane for conventional wing-borne flight, control surfaces (ailerons) may be provided in the wings to assist or to substitute for the thrusters in providing a counteracting moment to balance the rotor torque. Similarly, conventional rudder and elevator surfaces may be provided to assist or substitute for the thrusters to control the direction of flight in this mode. The thrusters may, in one embodiment, be embedded in canard-type control surfaces mounted to a boom extending forward (i.e. upstream) from the main rotor disk.

### BRIEF DESCRIPTION OF THE DRAWINGS

Embodiments of the present invention will now be described in detail with reference to the accompanying drawings, in which corresponding parts are given like reference numbers. In the drawings:

FIG. 1 shows a schematic side view of a first rotorcraft incorporating the control arrangement of the present invention;

FIG. 2 is a perspective view showing the relative disposition of the rotor and thrusters in a first control arrangement;

FIG. 3 is an axial view from above the rotor, showing the thruster forces in hovering flight;

FIG. 4 is a view similar to FIG. 3, showing the thruster forces in forward flight.

FIG. 5 is a view similar to FIG. 3 showing the thruster forces in sideways flight.

FIG. 6 is a perspective view of a tilt-rotor aircraft using the control arrangement of the present invention, in rotor-borne flight configuration.

FIG. 7 is a perspective view of the tilt-rotor aircraft of FIG. 6 in wing-borne flight configuration.

### Rotorcraft Structure

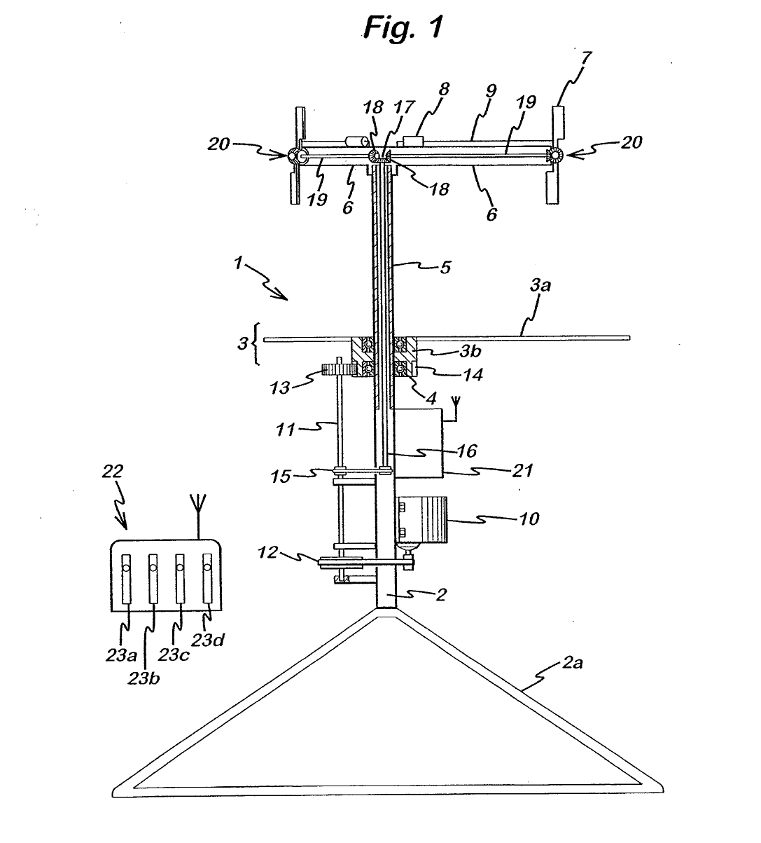

Referring now to FIG. 1, the rotorcraft 1 comprises a fuselage 2 in the form of an upright elongate beam. At the upper end of the fuselage 2 a main rotor 3 is attached to the fuselage. The main rotor 3 comprises rotor blades 3a and a rotor hub 3b. The rotor hub 3b is mounted to the fuselage 2 by main rotor bearings 4.

At the lower end of the fuselage 2 an undercarriage 2a in the form of a pair of skids is mounted to the fuselage.

Extending upwardly from the fuselage 2 through the centre of the main rotor is a boom 5, at the upper end of which are mounted three radial arms 6. At the radially outer end of each radial arm 6 is a thruster 7. In the embodiment shown, the thrusters 7 are variable-pitch propellers with their axes arranged tangentially to the radial arms 6 in the same circumferential sense. A pitch control actuator 8 is associated with each thruster 7 by means of a pitch control rod 5.

Drive for the main rotor 3 and the thrusters 7 is provided by a motor 10 mounted to the fuselage 2. The motor 10 drives a transfer shaft 11 by means of a toothed belt drive 12. The transfer shaft 11 extends in parallel to the fuselage 2 and at its upper end has a drive gear 13 to engage with gear teeth 14 on the main rotor hub 3b.

Intermediate the length of the transfer shaft 11 a further toothed belt drive arrangement 15 transmits power from the transfer shaft 11 to a transmission shaft 16 which extends through the centre of the main rotor bearings 4 and along the length of the boom 5 to terminate in a bevel gear 17. The bevel gear 17 is engaged by three conical gears 18, each of which is mounted to a respective drive shaft 19 housed in a respective radial arm 6. At the radial outer end of the radial arm 6 the drive shaft 19 provides power to a thruster 7 by means of a second bevel gear assembly 20.

The embodiment shown in FIG. 1 is a remotely-controllable pilot-less aircraft and includes a control signal receiver 21 which is linked to a control actuator (not shown) for controlling the power output of the motor 10. The control signal receiver 21 is also linked to the pitch control actuators 8, so that the amount and circumferential direction of thrust produced by each thruster 7 may be varied independently of the other thrusters. It will be appreciated, however, that a manned version of the rotorcraft will include a pilot's cabin provided with control inputs for applying control signals to the actuators 8. The pilot's cabin may be mounted to the boom 5 or to a radial arm 6 above the main rotor 3, or mounted to the boom 5 below the main rotor.

The remote control system comprises a transmitter 22 which transmits a four-channel control signal responsive to each of four control inputs 23a, 23b, 23c and 23d. In the present embodiment, three control inputs 23b, 23c and 23d have a neutral central position and are moveable to positive and negative positions on either side of their respective neutral positions. These three controls are set so that the neutral position of the control input corresponds to a steady state of the aircraft movement controlled by the respective control channel. Movement of one of the control inputs 23b, 23c or 23d to the positive side of the neutral position causes one or more of the actuators 8 to move in one direction from its neutral position by an amount proportional to the amount of displacement of the control input. Control input 23a is linked to the motor speed control. To increase the amount of thrust generated by the main rotor 3, the control input 23a is moved toward the upper end of its range, and to decrease the thrust the control input is moved toward the lower end of its range. The lifting force produced by the main rotor is controlled by varying the motor speed, to lift the aircraft off the ground and to control altitude.

Control inputs 23b, 23c and 23d are operable to control the direction of horizontal flight, and the azimuth of the aircraft (i.e. the direction in which the aircraft is “facing”), as will be described later.

The main rotor 3 of the rotorcraft shown in FIG. 1 is a fixed-pitch rotor, so that the amount of lift generated by the rotor is controlled by varying the engine speed. It is however foreseen that the main rotor 3 may be provided with variable-pitch blades and a collective pitch control may be provided under the control of the control signal receiver 21. The rotor may then be a constant-speed rotor with lift varied by adjusting the collective pitch of the rotor blades.

It will be understood that in either case a variation in lift will result in a change in torque applied to the rotor, and will require a corresponding change in the moment applied by the thrusters to control yawing of the fuselage.

In the craft shown in FIG. 1, the centre of gravity of the aircraft is arranged to be below the disc of the main rotor 3, to give a measure of inherent stability to the aircraft. The centre of gravity position may alternatively be at or above the rotor disc position, but in such embodiments sensors may be required to detect pitching and rolling of the craft so that automated compensation can be applied to maintain attitude.

### Rotorcraft Operation

To operate the rotorcraft shown in FIG. 1, the craft is stood on its skids or undercarriage 2a and the motor 10 is started to rotate the main rotor 3 and the thrusters 7. To effect a vertical take-off control input 23a is moved toward the “positive” side of its neutral position, increasing the motor 10 speed to increase the amount of lift produced by the main rotor 3, while the pitch controls of the thrusters are held at positions which provide equal amounts of thrust from each of the three thrusters to counteract the torque applied to the main rotor. As the motor speed increases, both the lift from the main rotor and the thrust from the thrusters increase substantially together, until the lift produced by the main rotor is sufficient to overcome the weight of the aircraft and lift-off occurs. The pitch control actuators 8 of the thrusters 7 are then finely trimmed to produce equal amounts of thrust at each thruster to counteract any tendency of the fuselage of the aircraft to yaw. Since the thrusters are symmetrically distributed, equalising their thrusts produces only a moment to counteract the rotor torque and no nett lateral force. Once the required hovering height has been reached, the motor 10 speed is decreased until the lift and weight of the aircraft are in equilibrium and hovering is achieved and control input 23a is trimmed so that the neutral position of the control input 23a corresponds to the motor speed required for hovering. To descend, the motor speed is reduced to decrease the lift by moving the control input 23a toward the negative side of its neutral position. During these variations of lift, the torque applied to the rotor will change and the magnitudes of the thrust forces produced by the thrusters are controlled so that the moment produced by the thrusters is equal to the rotor torque, thus preventing yawing of the fuselage about the vertical axis.

Control of the aircraft in yaw, i.e. control of the direction in which the aircraft is “pointing”, is effected by the control input 23b, which operates to vary the thrust produced by the thrusters 7 in unison, either increasing or decreasing the thrust forces produced. To effect a rotation of the fuselage in yaw to the left (anti-clockwise as seen from above), the control input 23b is momentarily moved from its neutral position to its positive side. This causes all three actuators 8 to increase the pitch of the thruster propellers by an amount proportional to the movement of the control input 23b from its neutral position, and thus increase their thrusts. The moment applied to the fuselage by the thrusters then exceeds the torque applied to the fuselage by the main rotor, causing the fuselage to yaw to the left. To stop the rotation of the fuselage, the control input 23b is moved momentarily to its negative side and then returned to the neutral position.

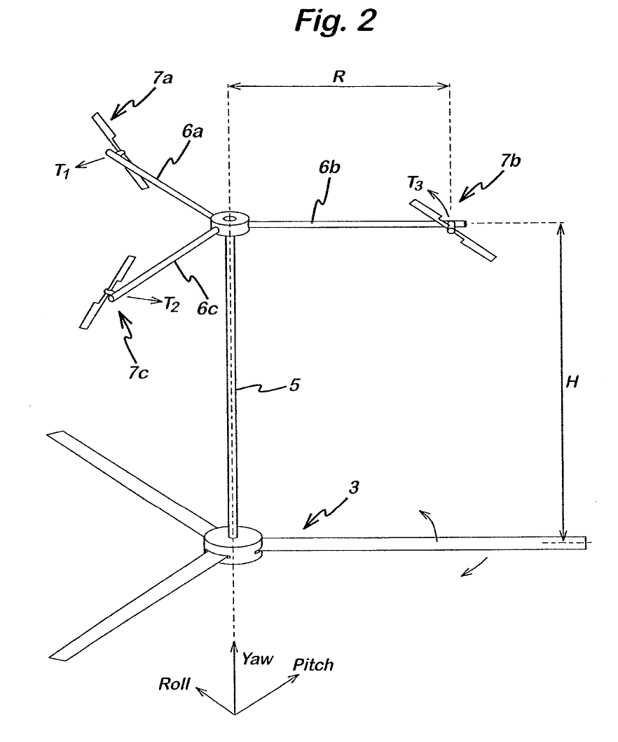

Referring now to FIG. 2, the relative dispositions of the three thrusters and the main rotor of the aircraft are shown in perspective view, in relation to a three-axis coordinate system with its origin at the centre of gravity of the aircraft. The axis marked “roll” is the longitudinal forward direction of the fuselage. The axis marked “pitch” is the horizontal axis transverse to the fuselage, and the vertical axis is marked “yaw”.

Forward and/or sideways translation of the aircraft is achieved by tilting the aircraft about the pitch and/or the roll axes, respectively, in order to tilt the rotor disk and thus produce a horizontal component of the rotor lift force.

Taking the roll axis as the “forward” direction of the aircraft fuselage, the radial arm 6a extends forward from boom 5 and the “forward” thruster 7a is mounted at the tip of radial arm 6a. Similarly, the right hand or starboard thruster 7b is mounted to the right hand or starboard radial arm 6b, and the left-hand or port thruster 7c is mounted to the left-hand or port radial arm 6c.

In order to control the aircraft in rotation about the three principal axes, the propellor pitch control actuators 8 associated with the respective thrusters 7 are operated in order to vary the magnitude of the thrust forces produced by the thrusters so that the resultant of the three thruster force vectors provides a moment to counteract the rotor torque and, if required, a radial force in a plane parallel to the main rotor disc. The radial force, if aligned with the fore-and-aft axis of the aircraft, will produce a positive (forward) or negative (rearward) pitching moment which will tilt the aircraft either forward or rearward and promote either forward or rearward translation of the aircraft.

If the radial force is aligned with the transverse axis of the aircraft, then the radial force will provoke a rolling of the aircraft to the left or to the right. This rolling movement will incline the main rotor disc plane and a sideways movement of the aircraft will ensue.

By arranging for the radial force to be at a selected angle relative to the fore-and-aft axis (roll axis) of the aircraft, combinations of rolling and pitching. movements can be produced which result in the aircraft translating in the direction of the radial force.

To control the aircraft in yaw, i.e. to control the azimuth direction of the fore-and-aft axis of the aircraft, the magnitudes of the thruster forces are increased or decreased in unison so that the resultant moment on the aircraft fuselage is slightly greater or slightly less than the main rotor torque. This unbalanced torque causes the aircraft fuselage to rotate about the main rotor axis, providing control over the direction in which the aircraft is pointed.

### Control of the Thrusters

In the embodiment illustrated in FIG. 1, each of the thrusters 7 is constituted by a variable-pitch propeller controlled by a pitch control actuator 8 through a pitch control rod 9. While the direction of rotation of the propeller remains constant, the circumferential direction of the thrust vector may be varied by setting the propeller blades at a positive or a negative pitch angle. Each thruster may thus deliver a thrust force arranged in a clockwise or anti-clockwise direction relative to the main rotor axis (seen from above). The pitch angle of the thruster propeller blades and the rotation speed of the thruster propeller control the magnitude of the force produced.

The rotorcraft shown in FIG. 1 is remotely controlled, using three separate control channels to control pitch, roll and yaw of the rotorcraft. A fourth control channel is used to control the main rotor speed by controlling the motor 10.

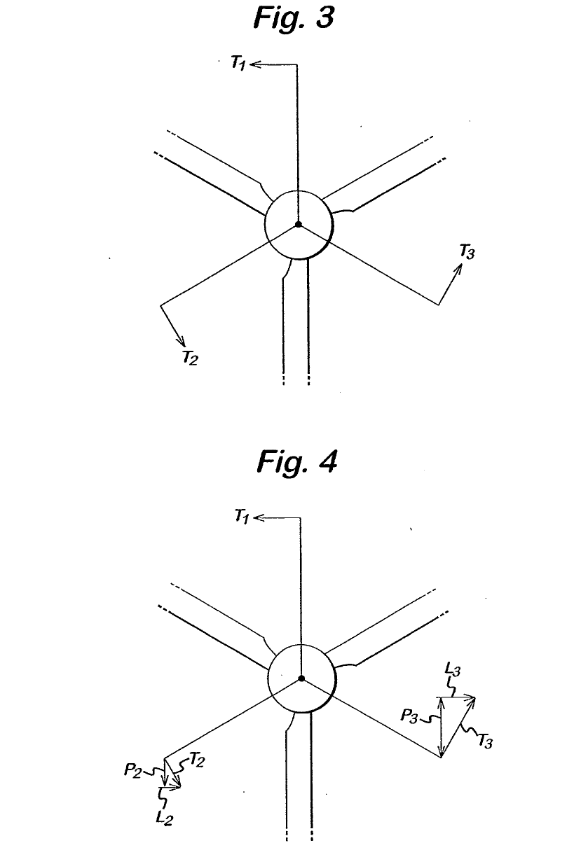

Referring now to FIG. 3, there is seen a view from above schematically illustrating the main rotor 3 and the three thrusters 7. The main rotor rotates in an anti-clockwise direction as seen from above, and thus the fuselage experiences a reaction to the main rotor torque as a clockwise turning movement. The fore-and-aft direction of the aircraft is vertically upwards in the Figure, and thus the forward thruster 7a is uppermost. The thrusters 7a, 7b and 7c are arranged so that one of the thrusters is directly in front of the main rotor axis, relative to the aircraft fuselage, and the other two thrusters 7 are carried on arms extending rearwardly and outwardly at 120o to the aircraft's longitudinal axis.

### Hovering Flight

In hovering flight, the thrust T1, T2 and T3 produced by each of the thrusters 7a, 7c and 7b respectively is made equal, so that the resultant force at the upper end of the boom 5 is a pure couple in the anti-clockwise direction, to balance the clockwise reaction moment from the main rotor 3. In other words, the upper end of the boom 5 experiences no lateral force but only a twisting force. The magnitude of each of the thrusts T1, T2 and T3 will depend on the length R of the radial arms 6, and on the instantaneous value of the torque being applied to the main rotor 3. In hovering flight, any tendency of the aircraft to yaw will be corrected by either increasing or decreasing the thrusts T1, T2 and T3 of the thrusters 7 in unison. Steady hovering may be assisted by a feedback control system wherein a gyroscopic detector detects yaw of the aircraft fuselage and provides a signal to the pitch control actuators 8 either to increase or decrease the pitch of the thruster propellers in accordance with the direction of yaw detected, to cancel any undesired yawing rotation. The control channel dedicated to yaw control, responsive to input 23b, is trimmed so that in a stable hover, the control input is in its neutral position. To “turn” the aircraft, control input 23b is moved toward its positive side, and all three actuators 8 increase the pitch of their respective thruster propellers in unison by an amount proportional to the control input movement. Forces T1 T2 and T3 increase together, and the aircraft turns in the anti-clockwise direction i.e. to the left. The aircraft is turned to the right, still hovering, by moving control input 23b to its negative side.

### Forward Flight

To move from hovering flight to forward flight, the control system is required to produce at the upper end of the boom 5 a lateral force directed forwardly, in order to pitch the aircraft nose-down. This will incline the disc of the main rotor so as to direct the main thrust of the rotor 3 upwardly and forwardly, and thus provoke forward flight.

To pitch the aircraft nose-down, the thrust T2 of the left-hand thruster 7 is decreased, and the thrust T3 of the right-hand thruster is increased by a like amount. The force T1 of the forward thruster 7 is left unchanged. This situation is illustrated in FIG. 4, with the longitudinal and lateral components of the thrust forces T2 and T3 shown vectorially.

The moment generated by the thrusters 7 to resist main rotor torque is unchanged, since the decrease in moment about the rotor axis resulting from the decrease in thrust T2 is compensated by the increase in moment produced by increasing the thrust T3.

Resolving the thrust forces T1, T2 and T3 in the longitudinal direction (i.e. vertically as shown in FIG. 4) the lateral components L2 and L3 of the thrust forces T2 and T3 add to balance out the sideways component of thrust T1. Thus no nett side force is produced and there is no tendency for the aircraft to roll.

The longitudinal component P2 of the thrust force T2 acting rearwards is smaller than the longitudinal component P3 of the thrust T3 acting forwards, and there is no longitudinal component in the thrust T1 produced by the forward thruster 7. Thus, the upper end of the boom 5 experiences a nett forward force equal to (P3−P2) This force tends to pitch the aircraft nose down, tilting the main rotor disc forward. The lift force produced by the rotor then has an upward component to support the aircraft and a forward component to produce forward flight. The power to the lift rotor will have to be increased, since the vertical component of lift is reduced by rotor tilt, and the lateral force produced by the thrusters will have a small downward component when the nose of the aircraft is pitched down.

When the pilot wishes to fly the aircraft forward, a pitching control input 23c of the remote control transmitter is moved from its neutral position to a “forward” position by an amount proportional to the amount of forward pitching required. A signal is sent to the control signal receiver 21, commanding an increase of T3 and an equal decrease in T2. In accordance with the amount of forward pitching required, the control circuit increases the thrust T3 of thruster 7c and decreases the thrust T2 of thruster 7b by equal amounts, by operating the pitch control actuators 8 connected to the thrusters 7c and 7b.

It will be appreciated that, as the rotor disc is tilted out of the vertical, a slight increase of lift will be required to maintain height since the vertically upward component of the lift produced by the rotor will be slightly decreased. This increase in the lift requirement will slightly increase the rotor torque requirement, and the three thrusters will have to increase their thrust slightly to compensate for the increased torque requirement. Furthermore, as the centre of gravity of the aircraft is below the rotor, then a tilting out of the vertical will produce a restoring moment due to the misalignment of the lift and weight vectors. This restoring moment eventually balances the pitching moment produced by the thrusters, resulting in a stable forward flight.

To return to hovering flight from forward flight the control input 23c is returned to its neutral position, and the thrusts T1, T2 and T3 of the three thrusters are once again made equal by increasing T2 and decreasing T3. The nose-down pitching moment applied to the aircraft is thus removed, and the aircraft returns to its stable condition with its centre of gravity beneath the main rotor axis.

### Sideways Flight

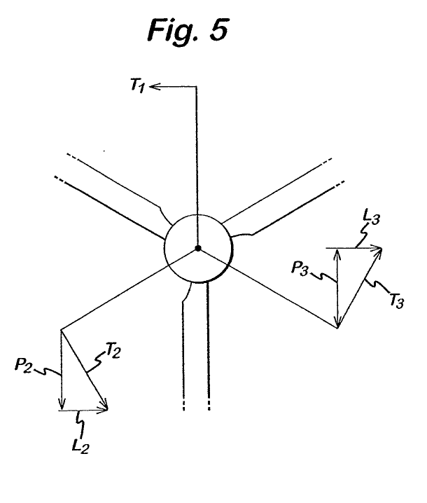

In order to direct the aircraft to fly in a “sideways” direction, a rolling moment is required. Thus, a sideways force must be applied at the upper end of the boom 5. FIG. 5 illustrates the variation in thrusts necessary from the thrusters 7 to achieve sideways flight, towards the right as seen in the Figure.

From the hovering state, with T1, T2 and T3 equal, the thrust T2 of the left-hand thruster is increased, and the thrust T3 of the right-hand thruster is also increased by the same amount. The thrust T1 of the forward thruster is decreased by twice the amount of this increase, in order to preserve equilibrium in yaw.

Resolving the thrust forces longitudinally, the forward component P3 of thrust T3 balances the rearward component P2 of thrust T2, and thus no pitching results.

Forces to the right, i.e. the lateral components L2 and L3 of the thrust forces T2 and T3, exceed the force to the left of thrust T1, and thus a nett force to the right is applied to the top of boom 5, causing the aircraft to roll to the right. This tilts the main rotor disc and causes the aircraft to fly to the right. Again, the main rotor lift will have to be increased slightly to compensate for the inclination of the main rotor thrust direction, and any increase in rotor torque will require compensation by a slight and equal increase in all three of the thrusts T1, T2 and T3.

When the pilot wishes to fly the aircraft to the right, the rolling control 23d of the remote control transmitter is moved from the neutral position to a “positive” position by an amount corresponding to the sideways speed required. The control circuit increases the thrusts T2 and T3 by corresponding equal amounts and decreases the thrust T1 by twice that amount, by operating the pitch control actuators 8 of the thrusters 7a, 7b and 7c.

To roll the aircraft to the left the control input 23d is moved to a “negative” position by an amount proportional to the sideways speed required. The actuators 8 decrease the thrust forces T2 and T3 by a corresponding amount from the equilibrium hovering value and increase thrust force T1 from the equilibrium hovering value by twice the amount of that decrease. This results in the moment applied at the boom being unchanged, and a lateral force being applied toward the left at the upper end of the boom, causing the aircraft to roll to the left. In both cases, the rolling is opposed by the restoring movement of the aircraft's weight, until a steady sideways speed is reached.

Returning the control input 23d to its neutral position equalises the thrusts T1, T2 and T3, and the restoring moment due to the weight returns the aircraft to the hover.

### Alternative Control Arrangement

In order to make flying the aircraft more intuitive, the four separate control inputs 23a, 23b, 23c and 23d may be combined into a single “joystick” type control and a single altitude (motor speed) control. The “joystick” control will have three degrees of freedom, e.g. fore and aft movement, side to side movement, and rotation of the joystick about its axis. Each one of these inputs will correspond to one control channel, and will result in changes in the thrusts of combinations of the thrusters 7. For example, rotating the joystick either clockwise or anti-clockwise about its axis may control the azimuth of the aircraft by increasing or decreasing the thrusts of thrusters 7 in unison from a neutral or equilibrium position. Fore-and-aft movement of the joystick may correspond to the pitching control effected by control input 23b in the previous example, so that a forward movement of the joystick from a neutral position will cause an increase in the thrust T3 of the right thruster and an equal decrease in the thrust T2 of the left thruster. Similarly, rearward movement of the joystick will cause T2 to increase and T3 to decrease by an equal amount, the amounts corresponding to the amount of joystick movement from the neutral position.

Lateral movements of the joystick will cause simultaneous variation in the thrusts of all three thrusters by increasing the thrust T2 and T3 by equal amounts and decreasing the thrust T1 by twice that amount, or vice versa in order to fly the aircraft to the right or to the left, respectively.

The joystick control may thus be used simultaneously to apply pitching and rolling movements by moving the joystick both laterally and longitudinally. Furthermore, a simultaneous yawing of the aircraft may be applied by rotating the joystick. A separate “throttle” control, and optionally a main rotor pitch control, may be provided as separate or combined control inputs on one or more control channels.

When the joystick is moved to an arbitrary position away from its central neutral position the control circuitry in the transmitter will detect separately the amount of lateral control deflection, longitudinal control deflection, and rotary (yawing) control deflection, and will convert these into increases and decreases in the thrusts T1, T2 and T3 of the thrusters required to effect the various aircraft movements. The increases and decreases for each thruster are then summed and a signal is sent to the receiver so that the thrust values T1, T2 and T3 can be increased or decreased by the sum of the three required changes, so that the aircraft will enter the new flight regime. It is foreseen that this alternative control arrangement may be embodied by a mechanical linkage joining a control column which is movable in two horizontal directions and is rotatable about a vertical axis to control inputs for the thrusters.

### Tilt-Rotor Craft Structures

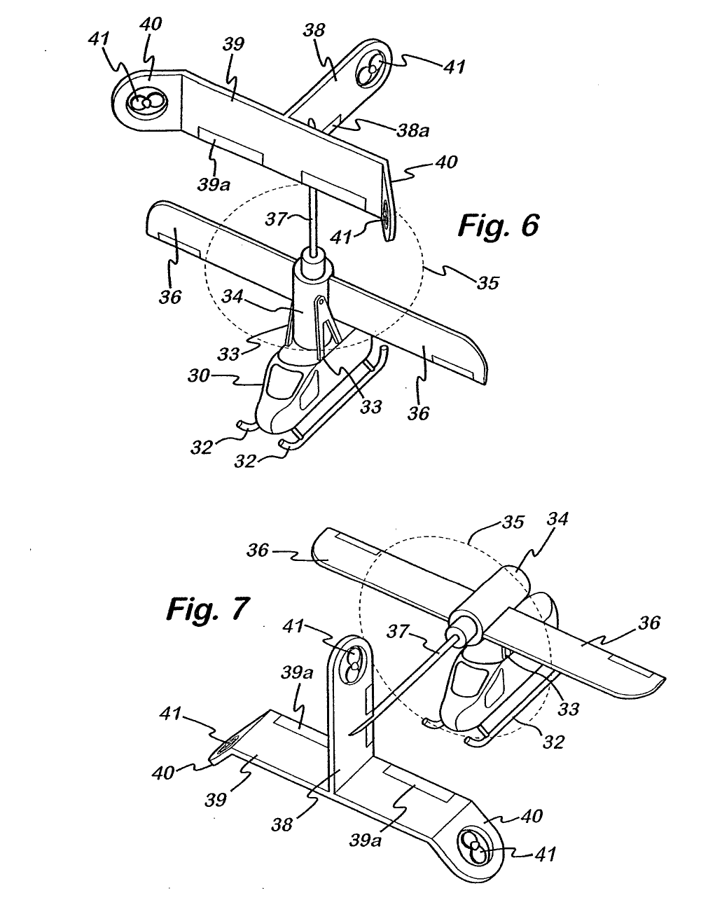

FIGS. 6 and 7 illustrate a tilt-rotor aircraft incorporating the control arrangement of the present invention.

Referring to these Figures, the tilt-rotor aircraft comprises a fuselage 30 housing a control cabin 31 and provided with undercarriage skids 32.

Mounted above the fuselage between a pair of mounting brackets 33 is an engine pod 34, which supports a main rotor 35 at its forward end. A pair of wings 36 extend laterally from the engine pod 34, the plane of the wings being perpendicular to the plane of the main rotor 35. Extending forwardly from the main rotor 35 is a boom 37, to the forward end of which are attached three control surfaces. Aligned with the fore and aft axis of the aircraft is a rudder 38, and extending laterally are a pair of elevators 39. The elevators 39 have anhedral tip sections 40 inclined downwardly at approximately 60°. In the tip sections 40 of the elevators, and at the tip of the rudder 38, thrusters 41 are mounted within the control surfaces. The thrusters are set in planes which are substantially radial with respect to the main rotor 35, so that they can provide thrust in circumferential directions with respect to the main rotor.

The engine pod 34, wings 36, boom 37 and control surfaces 38 and 39 are pivotable, as a unit, relative to the fuselage 30 between the “vertical” position shown in FIG. 6 and a “horizontal” position shown in FIG. 7. The position shown in FIG. 6 is adopted for rotor-borne flight during landing and take-off and for hovering. The position shown in FIG. 7 is adopted for higher-speed forward flight, wherein the aircraft is supported by wings 36.

Wings 36 are provided with conventional aileron surfaces 36a, and may also be provided with lift-increasing devices such as flaps or slats (not shown). The control surfaces 38 and 39 may be provided with a movable rudder 38a and movable elevator portions 39a, as will be described below.

The aircraft shown in FIGS. 6 and 7 is intended to land and take off vertically, in the configuration shown in FIG. 6, and to transition to the configuration shown in FIG. 7 for forward flight.

During the landing and take off phases, the thrusters 41 are operated to counteract the torque of the main rotor 35 to control yawing of the aircraft, and to provide forward and lateral flying movements at low speed. Once the aircraft has lifted off, the thrust from the main rotor is increased simultaneously with a tilting of the engine pod 34 forward, so that the aircraft's forward speed is built up. As the forward speed increases, the wings 36 provide increasing amounts of lift to support the weight of the aircraft, and the engine pod 34 may be tilted further towards the horizontal position shown in FIG. 7 so that the main rotor eventually provides only forward thrust to propel the aircraft while the weight of the aircraft is supported by the wings.

The control surfaces 38 and 39 are ineffective during hovering flight, due to the low aerodynamic forces produced at such low air speeds. However, as the aircraft's forward speed is increased, the rudder 38 and elevator 39 may generate sufficient aerodynamic forces to control the flight direction of the aircraft, and thus operation of the thrusters 41 may be gradually diminished as the aircraft's forward speed builds.

Wings 36 are mounted to the engine pod 34 so as to rotate therewith. In this arrangement with the aircraft configured for vertical flight the wings provide a minimum resistance to the downwash from the main rotor. It is however foreseen that the wings 36 may be mounted directly to the fuselage of the aircraft, optionally being positioned so as to minimise their obstruction to the rotor downwash.

In order to make the transition from forward flight to hovering flight for landing, the aircraft speed is decreased by reducing the main rotor thrust and simultaneously the engine pod 34 is rotated from its horizontal position to the vertical position. During this transition phase, the lifting force generated by the wings 36 will decrease but the amount of lifting force generated by the main rotor 35 will increase, and the combined lifting forces will continue to support the weight of the aircraft. Once the “vertical” position shown in FIG. 6 has been reached, the aircraft is fully supported by the main rotor lift and control of the aircraft roll, pitch and yaw is effected by use of the thrusters 41.

The aircraft's control system will preferably be computerised so that the instantaneous forward speed and attitude of the aircraft, as well as its configuration, will be monitored, and any control input made by the pilot will be converted into appropriate control deflections of the movable portions of the rudder and elevator 38a, 39a, movement of the ailerons 36a, and control of the thrust produced by the thrusters 41.

The main rotor 35 of the aircraft may be a variable-pitch rotor provided with collective pitch control only, or may be a fixed pitch rotor. Likewise, the thrusters 41 may be variable-pitch fans or propellers, or may be jet thrusters aligned in the circumferential direction of the main rotor.

### Additional Applications of the Control System

In addition to the control of rotorcraft in lateral directions described above, the thrusters array may be used to exert horizontal force to control the horizontal positioning of, for example, a floating body such as a ship or aerostat, a body supported on castors, a hovercraft, or a load suspended on a cable. This application could find utility in controlling the end of a cable lowered from a hovering aircraft for retrieving a load, or for placing a suspended load precisely on the ground.

The control system using an array of thrusters may also be used as an alternative to conventional control surfaces such as ailerons, elevator and rudder in a fixed wing aircraft, by mounting the array to the aircraft fuselage with the thrusters directed tangentially to the longitudinal axis, either forward or aft of the wing centre of lift.

The scope of the present disclosure includes any novel feature or combination of features disclosed herein, either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any further application derived herefrom. In particular, with reference to the appended claims, features from dependent claims may be combined with those of the independent claims and features from respective independent claims may be combined in any appropriate manner and not merely in the specific combinations enumerated in the claims.

1. A rotary wing aircraft comprising: a fuselage; a main rotor rotatable in a main rotor plane relative to the fuselage for supporting the aircraft in flight; and a plurality of control thrusters each operable to provide a thrust force acting in a tangential direction relative to the main rotor and in a plane parallel to and spaced from the main rotor plane.

2. A rotary wing aircraft according to claim 1, wherein the plurality of control thrusters comprises a pair of oppositely directed thrusters, the pair being mounted for selective rotation relative to the fuselage about the main rotor axis.

3. A rotary wing aircraft according to claim 1, wherein the plurality of thrusters comprises three or more thrusters spaced in the circumferential direction of the main rotor.

4. A rotary wing aircraft according to claim 3, wherein the thrusters are equally spaced in the circumferential direction of the main rotor.

5. A rotary wing aircraft according to claim 2, wherein the thrusters are mounted to respective radial arms extending from a boom mounted to the fuselage and extending axially through the main rotor hub.

6. A rotary wing aircraft according to claim 5, wherein the thrusters are mounted on radial arms extending from the boom, the radial arms being rotatable about the main rotor axis to vary the circumferential positions of the thrusters relative to the main rotor.

7. A rotary wing aircraft according to claim 1, wherein each thruster comprises a propellor rotating in a plane radial to the main rotor.

8. A rotary wing aircraft according to claim 7, wherein the propellor is a variable-pitch propellor adapted to deliver a thrust force in either circumferential direction relative to the main rotor.

9. A rotary wing aircraft according to claim 7, wherein the propellers of the thrusters are driven by a transmission shaft extending axially through the main rotor hub.

10. A rotary wing aircraft according to claim 1, wherein each thruster comprises a directable reaction jet.

11. A rotary wing aircraft according to claim 1, wherein the rotor is positioned above the fuselage, and the thrusters are positioned above the rotor.

12. A rotary wing aircraft according to claim 11, comprising a second array of thrusters mounted below the rotor.

13. A rotary wing aircraft according to claim 1, wherein the main rotor is a fixed-pitch rotor.

14. A rotary wing aircraft according to claim 1, wherein the main rotor has collective pitch control.

15. A rotary wing aircraft according to claim 1, wherein the main rotor is at least partially surrounded by a protective shield.

16. A rotary wing aircraft according to claim 15, wherein the shield comprises a duct enclosing the main rotor.

17. A remotely-piloted rotary wing aircraft according to claim 1.

18. A method of controlling a rotary wing aircraft comprising a fuselage, a main rotor and an array of thrusters mounted to the fuselage and arranged in a plane parallel to and spaced from the plane of the main rotor to deliver thrust force in circumferential directions relative to the main rotor, the method comprising: controlling the magnitude and circumferential direction of the force produced by each thruster to produce a moment to oppose torque applied to the main rotor and optionally a force in a selected radial direction relative to the main rotor axis.

19. A method according to claim 18, wherein the array of thrusters comprises two oppositely directed thrusters, and the radially-directed, force is produced by a difference in the magnitudes of the forces produced by the respective thrusters, and wherein the radial direction of the radially-directed force is selected by rotating the array of thrusters relative to the fuselage about the main rotor axis.

20. A method according to claim 18, wherein the array of thrusters comprises three or more thrusters fixed in relation to the fuselage and spaced in the circumferential direction of the main rotor, and wherein the radially-directed force is produced by varying the magnitude and/or circumferential direction of the thrusts produced by the respective thrusters to produce a resultant force in a selected radial direction relative to the main rotor axis.

21. A tilt-rotor aircraft comprising a fuselage having a longitudinal and a transverse axis and a rotor mounted to the fuselage for tilting movement between a first position wherein the rotor is rotatable in a plane substantially parallel to the longitudinal and transverse axes and a second position wherein the rotor is rotatable in a plane substantially perpendicular to the longitudinal axis and parallel to the transverse axis, the aircraft further comprising: a plurality of control thrusters mounted for tilting movement with the rotor, each thruster being operable to provide a thrust force acting in a tangential direction relative to the rotor and in a plane parallel to and spaced from the plane of the rotor.

22. A tilt-rotor aircraft according to claim 21, further comprising a pair of wings mounted to the fuselage to support the aircraft in forward flight.

23. A tilt-rotor aircraft according to claim 21, further comprising a pair of wings mounted for tilting movement with the rotor with the chord direction of the wing being substantially aligned with the rotor axis.

24. A tilt-rotor aircraft according to claim 21, wherein the control thrusters are mounted to the radially outer ends of respective radial arms extending from a boom projecting axially of the rotor and tiltable therewith.

25. A tilt-rotor aircraft according to claim 24, wherein the radial arms are configured as aerodynamic control surfaces operable to control the aircraft in forward flight when the rotor is in its second position.

26. A tilt-rotor aircraft according to claim 25, wherein, when the rotor is in its second position, the radial arms are positioned forward of the fuselage and provide a vertical and a pair of horizontal control surfaces.

27. A tilt-rotor aircraft according to claim 26, wherein the horizontal control surfaces have anhedral tip sections, and respective thrusters are mounted in the tip sections.

28. A tilt rotor-aircraft according to claim 21, each thruster comprises a propellor rotating in a plane radial to the main rotor.

29. A tilt-rotor aircraft according to claim 27, wherein each thruster comprises a directable reaction jet.

30. A tilt-rotor aircraft according to claim 21, wherein the main rotor is a fixed-pitch rotor.

31. A tilt-rotor aircraft according to claim 21, wherein the main rotor has collective pitch control.

32. A tilt-rotor aircraft according to claim 21, wherein the rotor is enclosed by duct.

33. A flight control system for a rotary wing aircraft having a main rotor operable to produce a lift force for supporting the aircraft in flight, the control system comprising: a plurality of control thrusters each operable to provide a thrust force acting in a tangential direction relative to the main rotor and in a plane parallel to and spaced from the main rotor plane; and control means for controlling the magnitude and circumferential direction of the thrust produced by each thruster in dependance on control inputs applied by a pilot.

34. A flight control system according to claim 33, wherein the thrusters are propellers rotating in planes radial to the plane of the main rotor, and the control means comprises a respective actuator and a linkage operable by the actuator to vary the collective pitch of each propellor.

35. A flight control system according to claim 34, wherein the control means is operable to vary the pitch of one or more of the propellers in response to a single control input applied by the pilot.

36. A method of controlling a rotary wing aircraft comprising a fuselage, a main rotor and a plurality of control thrusters each operable to provide a thrust force acting in a tangential direction relative to the main rotor and in a plane parallel to and spaced from the main rotor plane the method comprising: determining a required direction of flight; adjusting the magnitude and/or direction of the forces produced by the thrusters so that their resultant is a moment counteracting the main rotor torque and a radial force directed in the required flight direction.

37. A method according to claim 36, wherein two oppositely-directed thrusters are provided, and wherein the direction of the radial force is controlled by rotating the pair of thrusters about the main rotor axis.

38. A method according to claim 36, wherein three or more thrusters are provided in circumferentially spaced relation with respect to the main rotor, and wherein the directions of the resultant radial force is controlled by varying the magnitude and/or circumferential direction of the force produced by each thruster.
